(19) United States
(12) Patent Application Publication
(10) Pub. No.: US 2010/0325624 A1
(43) Pub. Date: Dec. 23, 2010

(54) Method and System for Application Portability

(76) Inventors: Stephen John Bartolo, Allen, TX (US); Vishal Shashi Mehra, Plano, TX (US)

Correspondence Address: TEXAS INSTRUMENTS INCORPORATED, P O BOX 655474, M/S 3999, DALLAS, TX, 75265, US

(21) Appl. No.: 12/820,121

(22) Filed: Jun. 21, 2010

Related U.S. Application Data
(60) Provisional application No. 61/219,227, filed on Jun. 22, 2009.

(51) Int. Cl. G06F 9/445

(52) U.S. Cl. 717/176

(57) ABSTRACT

A method of deploying applications in an application deployment environment comprising a plurality of servers is provided that includes selecting an application for deployment on a first server in the plurality of servers, and activating an application configuration engine provided by a central deployment repository, wherein the application configuration engine instantiates the application on the first server based on configuration information for the application stored in the central deployment repository.

### CROSS-REFERENCE TO RELATED APPLICATIONS

This application claims benefit of U.S. Provisional Patent Application Ser. No. 61/219,227, filed Jun. 22, 2009, which is incorporated herein by reference in its entirety.

### BACKGROUND OF THE INVENTION

Information technology (IT) operations are a crucial aspect in the operation of most organizations. A primary concern to these organizations is business continuity, i.e., the organizations rely on their information systems to operate their daily business. If an application or system in a data center becomes unavailable, the operations of an organization may be impaired or even completely stopped. Thus, a reliable infrastructure is needed for IT operations to minimize possible disruption.

A primary purpose of an organization data center is to provide enterprise applications, i.e., services, which manage the core business and operational data of the organization. Such enterprise applications may be proprietary and developed internally by the organization, and/or may be purchased from enterprise software vendors. Often, these enterprise applications are supported by multiple host servers, each supporting one or more components of the applications. Some common components of such applications include databases, application servers, file servers, web servers, middleware, etc.

Currently available application deployment solutions for data centers provide the capability to virtualize physical server hardware into one or more virtual servers, each with highly customized combinations of application binaries, application data, configuration requirements, operating systems, and computation/memory requirements. Such solutions may optimize capital expense by allowing expensive server hardware to support multiple enterprise applications but may not optimize the expense of operating those applications.

With current technology, when an enterprise application is installed to operate with an operating system on a server, whether it is a virtual server or a physical server, a tightly coupled, unique execution environment is created on that server. With the use of current virtualization technologies, multiple of these tightly coupled unique environments may be provided on a single physical server to increase overall utilization of a server farm. While overall hardware costs for the data center are driven down through the use of virtualization, these costs are rapidly becoming a smaller and smaller component of the total cost of ownership (TCO) due to decreases in server hardware prices. Further, the operational cost of managing the use of the virtualization technologies and the tightly coupled environments of the enterprise applications is a comparatively larger component of the TCO.

### BRIEF DESCRIPTION OF THE DRAWINGS

Particular embodiments in accordance with the invention will now be described, by way of example only, and with reference to the accompanying drawings:

FIG. 1 shows a block diagram of a system in accordance with one or more embodiments of the invention;

FIGS. 2-10D show examples in accordance with one or more embodiments of the invention;

FIGS. 11-13 show flow diagrams of methods in accordance with one or more embodiments of the invention; and

FIG. 14 shows an illustrative computer system in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . . ” Also, the terms “couple” and “connect” and derivatives thereof are intended to mean an indirect, direct, optical, and/or wireless electrical connection. Thus, if a first device couples or connects to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

Embodiments of the invention provide for decoupling an application from the operating system of a server such that the application may be easily and quickly moved from one server/operating system environment to another while maintaining the current state of any data used by the application and any unique characteristics of the application configuration. An application is defined to be the set of software (not including the operating system) needed to provide a service to an end user. An application deployment framework (ADF) is provided that may be used to manage an application deployment environment. An application deployment environment is a set of servers (physical and/or virtual) configured to operate within the ADF to accept the deployment of one or more applications based on application configuration information stored in a central deployment repository, e.g., a central server or storage device. An application deployment environment may include any number of servers and may span multiple data centers. In general, embodiments of the ADF permit the creation of an application mapping that describes the operational needs of an application, e.g., the application binaries, the location(s) of the application data, the application configuration requirements, and any operating and computation/memory requirements, and stores this mapping in a central deployment repository, e.g., a central server. The application mapping is essentially a template of changes and actions that are required to instantiate the application for execution on a server. Further, in the ADF, the application binaries are stored in a central deployment repository, and the application data is decoupled from the application and stored/maintained in a central repository.

With the application mapping and a configuration control stub installed on a server/operating system in the application deployment environment, the ADF can be used to programmatically instantiate the application on the server/operating system environment. The ADF also provides for keeping the application mapping current during use of the application so that at any time the application can be replicated on another server/operating system environment in the application deployment environment without data loss and with up-to-date configuration requirements.

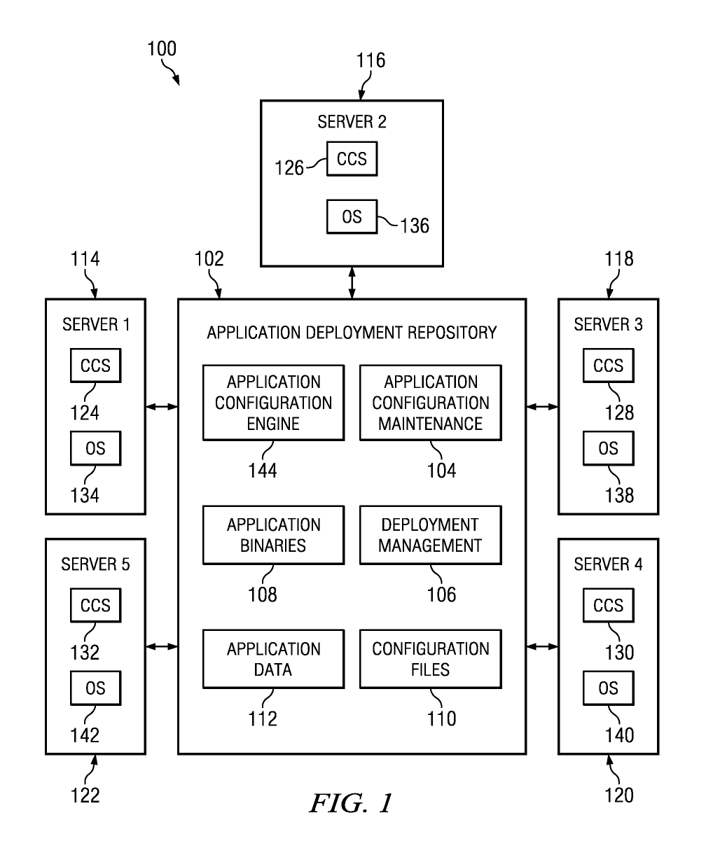

FIG. 1 shows a block diagram of a system (100) in accordance with one or more embodiments of the invention. The system (100) includes an application deployment repository (102), and five servers (114, 116, 118, 120, 122) connected to the application deployment repository (102). Five servers are shown in the block diagram for ease of depiction and explanation. The number of servers shown and described is not intended to limit the invention in any way. The application deployment repository (102) is configured to support application deployment to an application deployment environment, i.e., the servers (114, 116, 118, 120, 122) connected to it. The servers (114, 116, 118, 120, 122) are configured to operate within an application deployment framework (ADF), i.e., are configured to accept deployment of an application based on application configuration information stored in the application deployment repository (102). The connection between a server in the application deployment environment and the application deployment repository (102) may be any suitable connection that provides a communication channel between the two, such as, for example, wired or wireless communication media, a local area network, a virtual local area network, and/or a wide area network.

The application deployment repository (102) may be implemented with any suitable combination of hardware and software that provides for the storage and maintenance of the ADF components. For example, the application deployment repository (112) may be implemented with network-attached storage (NAS) (a computer connected to a network that provides file-based data storage to other devices in the network), a storage area network (SAN) (a network of storage devices not generally accessible through the regular network by other devices on the regular network and provided block-based data storage to the other devices), a SAN file system, and/or one or more servers.

Each of the servers (114, 116, 118, 120, 122) may be any suitable combination of hardware configured to support provision of one or more services, i.e., one or more applications, in a network. The servers (114, 116, 118, 120, 122) may be physical servers or virtual servers. That is, a physical server may be configured with virtualization software, e.g., VMware Server, Solaris Zones, Open Source Xen, etc., to support the execution of one or more virtual servers, each of which may provide the same or different services. In general, deployment of an application to a virtual server in the application deployment environment operates in the same fashion as deployment to a physical server. Although not specifically shown in FIG. 1, some servers in an application deployment environment may be configured as server clusters or server farms. Each of the servers (114, 116, 118, 120, 122) includes an operating system (134, 136, 138, 140, 142) and a configuration control stub (CSS) (134, 136, 138, 140,142). The operating systems (134, 136, 138, 140, 142) may be any suitable operating system, e.g., Solaris, Linux, Windows. Further, the operating systems (134, 136, 138, 140, 142) need not be the same for all servers.

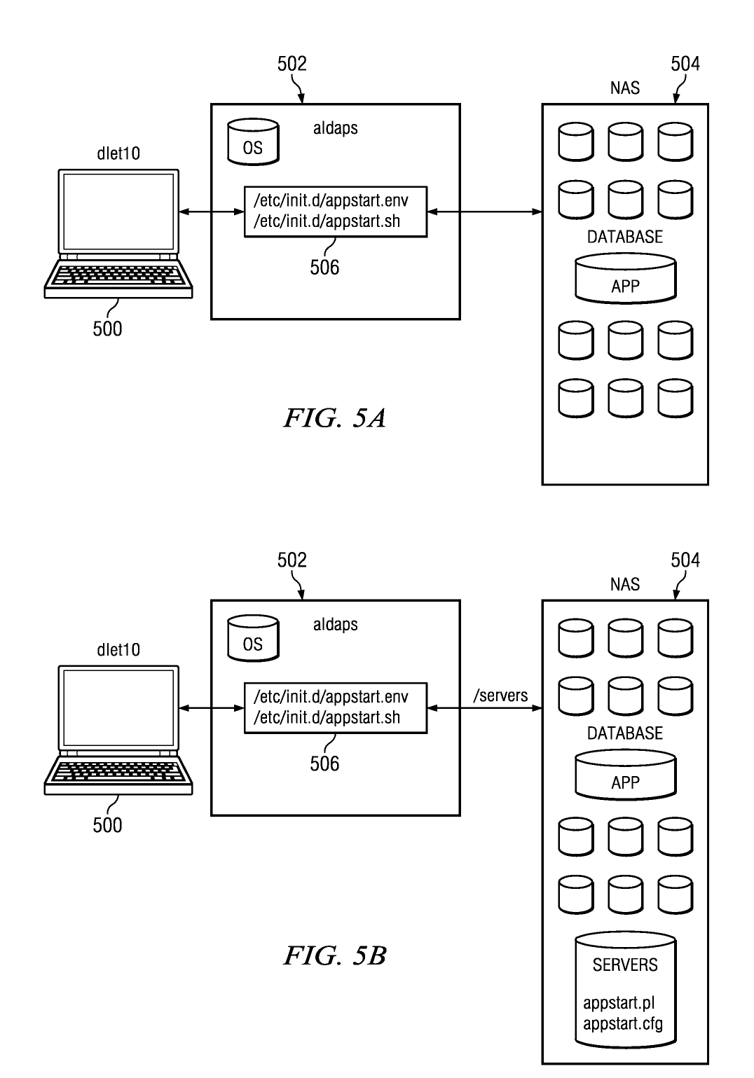

A configuration control stub (124, 126, 128, 130, 132) provides the functionality needed to initiate deployment of an application on the respective server (114, 116, 118, 120, 122). In one or more embodiments of the invention, a configuration control stub (124, 126, 128, 130, 132) accepts a parameter that is a unique identifier for an application that is to be deployed on its server, and includes the necessary information to establish communication with the application deployment repository (102) to initiate the deployment. In one or more embodiments of the invention, a configuration control stub (124, 126, 128, 130, 132) includes the necessary information to establish communication with the application deployment repository (102) and the application configuration engine (144) (described below) manages the deployment of the application to a server (114, 116, 118, 120, 122). An example of such an embodiment is described below in reference to FIGS. 5-15. In some embodiments of the invention, a configuration control stub (124, 126, 128, 130, 132) is the same for each type of operating system used in the application deployment environment.

The application deployment repository (102) provides ADF components including an application configuration engine (142), an application configuration maintenance component (104), and a deployment management component (106), and storage for application binaries (108), application data (112), and configuration data (110). The application binaries (108) are the binary files and other files needed to execute each version of each application configured for deployment in the application deployment environment, e.g., Oracle binaries, web server binaries, etc. The application data (112) includes the data generated by the use of each deployed application in the application deployment environment. The configuration files (110) store information about how to instantiate each deployable application on a server in the application deployment environment, i.e., application configuration information. For example, the configuration information for a deployable application may include the location(s) of the data for the application in the application data (112), the location(s) of the binaries for the application, instructions for creation of files and/or directories on a server, identification of any supporting applications required, locations of start up and shutdown scripts, the IP address needed to connect to the application, etc. In some embodiments of the invention, the application configuration information includes application configuration templates and instance configuration scripts (explained in more detail below in reference to FIGS. 5A-9).

The application configuration engine (142) provides functionality to cause an application to be instantiated for execution by a server in the application deployment environment according to application binaries (108) and application data (112) specified in one or more configuration files (110) corresponding to the application. In some embodiments of the invention, the application configuration engine (142) executes in the application deployment repository (102) and causes actions to occur on a server to instantiate an application being deployed to the server. In some embodiments of the invention, the application configuration engine (142) executes on the server to which an application is being deployed. In one or more embodiments of the invention, the application configuration engine (142) is an executable script that is executed by a server in the application deployment environment to which an application is being deployed to instantiate the application on that server.

The application configuration maintenance component (104) provides a user interface, e.g., a web interface, a text editor, external management console(s), etc., and other functionality for defining and maintaining the configuration files (110). In some embodiments of the invention, the application configuration maintenance component (104) provides configuration management, i.e., version control, of the configuration files. Any suitable configuration management software, e.g., IBM Rational ClearCase, Open Source Concurrent Versions System (CVS), GNU Revision Control System (RCS), a custom implementation, etc., may included as part of the application configuration maintenance component (104) to provide the version control. An application to be deployed may include one or more software packages, i.e., software instances, which are to be instantiated on the server in order for the application to operate. For example, the application may be an expense management system and some of the software instances in the expense management system may be database software, a web server, a job scheduler (for processing expense statements) and a monitoring tool (to monitor the application). In addition, a software instance may need to be configured in a unique way for the application. Accordingly, in some embodiments of the invention, configuration templates for commonly used software instances with suggested default values are available in the application configuration maintenance component (104) for use in generating the configuration information for the application.

The deployment management component (106) includes functionality to manage the deployment of applications in the application deployment environment. In some embodiments of the invention, the deployment management component (106) includes functionality for manual activation of the ADF to deploy applications in the application deployment environment. More specifically, the deployment management component (106) may provide interfaces to permit an administrator to specify an application to be deployed and the server to receive the deployment. In some embodiments of the invention, the administrator may use functionality of the deployment management component (106) to provide an application identifier of the application to be deployed to the configuration control stub on a server selected by the administrator for the deployment and to start the selected server such that the configuration control stub is activated. In embodiments of the invention in which the application configuration engine (142) is an executable script, the administrator may use functionality of the deployment management component (106) to pass a parameter to the script that specifies a selected application is to be deployed on a specific server and to start the server such that the configuration control stub is activated.

In one or more embodiments of the invention, the deployment management component (106) includes functionality to automatically deploy applications to servers in the application deployment environment. More specifically, the deployment management component (106) includes functionality to accept a request to deploy an application in the application deployment environment, to find available computing capacity on a server in the application deployment environment that is appropriately configured to support the requirements of the application, and to activate the configuration control stub on the selected server to cause the application to be deployed to that server. Further, the deployment management component (106) includes functionality to maintain an inventory of the servers in the application deployment environment, and to monitor the computational loads on those servers. In some embodiments of the invention, a grid management tool, e.g., Load Sharing Facility (LSF) from Platform Computing, is included in the deployment management component (106) to provide the automatic deployment.

The system (100) may operate as follows. A user, e.g., a system administrator, may use the application configuration maintenance component (104) to define configuration information for an application to be deployed and have that configuration information stored in the configuration files (110). The configuration information includes, among other things, identification of the binaries for the application stored in the application binaries (108) and the location(s) in the application data (112) where the data of the application is to be stored. The user may then use the deployment management component (106) to cause the newly configured application to be deployed on a server in the application deployment environment.

To initiate the deployment, the configuration control stub on the target server is activated. The configuration control stub then interacts with application deployment repository (102) to cause the instantiation of the application on the server. More specifically, the configuration control stub activates the application configuration engine (104), the configuration information for the application is retrieved from the configuration files (110), and the application is instantiated on the server under the control of the application configuration engine based on the configuration information. This instantiation process may include retrieving the binaries for the application from the application binaries (108) and configuring them to be executable by the server. This configuration may depend on the operating system installed on the selected server. Some operating systems, e.g., Windows, require that the application is physically installed on the operating system for execution. Other operating systems, e.g., Linux and Solaris, allow an application to be referenced from an external storage device, e.g., NAS or SAN, for execution. Further, appropriate links to the location(s) in the application data (112) are established.

Once deployed, the application is placed into service. As the application is used, any data created by use of the application is stored in the location(s) in the application data (112). Further, if changes are required to the application configuration due to, for example, software upgrades or updates, a user may use the application configuration maintenance component (104) to make any needed changes to the application configuration information and then use the deployment management component (106) to redeploy the application on the server without any loss of data. Further, if, at some point in time, the application needs to be moved to another server, e.g., due to server failure or need for additional compute capacity, or replicated on another server, the user can use the deployment management component (106) to deploy the application to another server in the application deployment environment using the current version of the application configuration information, again with no loss of data.

In one or more embodiments of the invention, the configuration control stubs ((124, 126, 128, 130, 132) are installed on each server (114, 116, 118, 120, 122) in the application deployment environment. In other embodiments of the invention, a configuration control stub is pushed to a server (114, 116, 118, 120, 122) when an application is to be deployed to that server. For example, an administrator may use the deployment management component (106) to access the server and install the configuration control stub. Or, in another example, if the deployment management component (106) includes functionality to automatically deploy applications as previously described, the deployment management component (106) may cause a configuration control stub to be installed on the server it selects for deployment of an application.

Further, in some embodiments of the invention, configuration control stubs are not installed on the servers in the application deployment environment. Rather than activating a configuration control stub on a server that then activates an application configuration engine to instantiate the application as previously described, the application configuration engine may be directly activated, e.g., by using a deployment management component to instantiate an application on a server. For example, the application configuration engine may be activated with parameters identifying an application to be deployed and the server to which it is to be deployed. The application configuration engine would then manage the instantiation of the specified application on the specified server based on the configuration information for that application. In this example, the deployment management component may include functionality to allow a user to manually activate the application configuration engine and/or may include functionality to automatically activate the application configuration engine after selecting a server for the deployment of an application specified by the user.

The software instructions, scripts, files, etc. included in components of the application deployment repository (102) may be stored on a computer readable medium such as a compact disc (CD), a diskette, a tape, a file, memory, or any other computer readable storage device or any combination thereof. The software instructions, scripts, files, etc. may be distributed to the application deployment repository (102) via removable computer readable media (e.g., floppy disk, optical disk, flash memory, USB key), via a transmission path from a computer readable medium on another computer system, a network-attached storage device, etc.

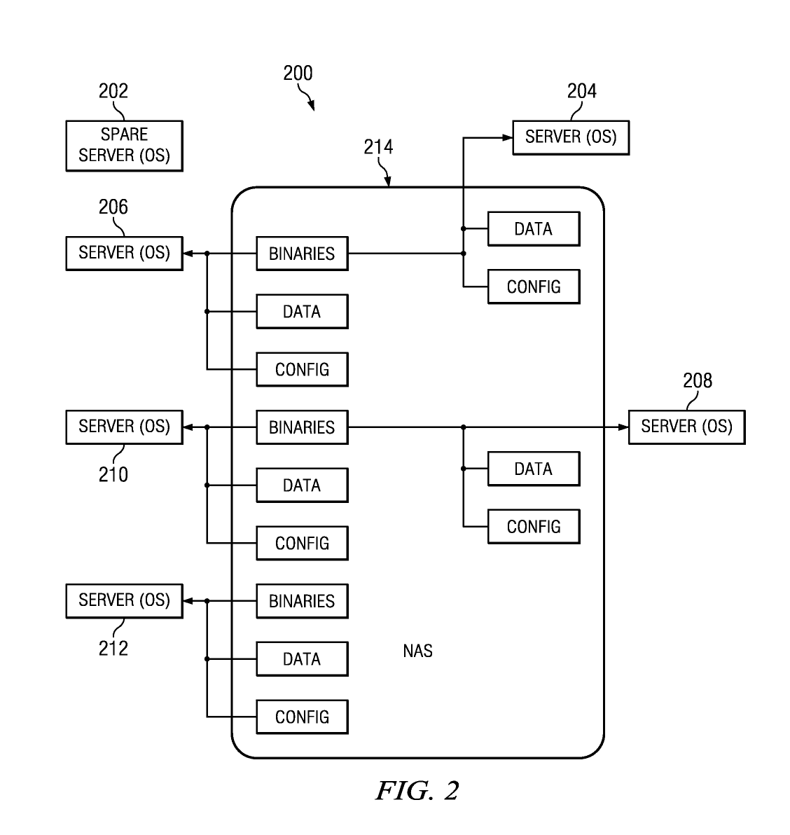

FIGS. 2-4 show examples of application deployment environments in accordance with one or more embodiments of the invention. The example application deployment environment (200) of FIG. 2 includes a spare server (202) and five servers with deployed applications (204, 206, 208, 210, 212). In this example, the application binaries, application data, and configuration information for the deployed applications are stored in network-attached storage (NAS) (214). The other components of the application deployment framework are not specifically shown. As can be seen from this example, the deployed applications each have their own data and configuration information. However, the deployed applications on server (204) and server (206) are instantiated from the same binaries, as are the deployed application on servers (208) and server (210). In this application deployment environment, application deployment is performed manually by a user as previously described. That is, to move an application from a server, e.g., server (206), to the spare server (202), a user selects the spare server (202) for the deployment, and manually activates the configuration control stub (not specifically shown) on the spare server (202) to initiate the deployment. During this process, the application running on server (206) is shut down and restarted on the spare server (202).

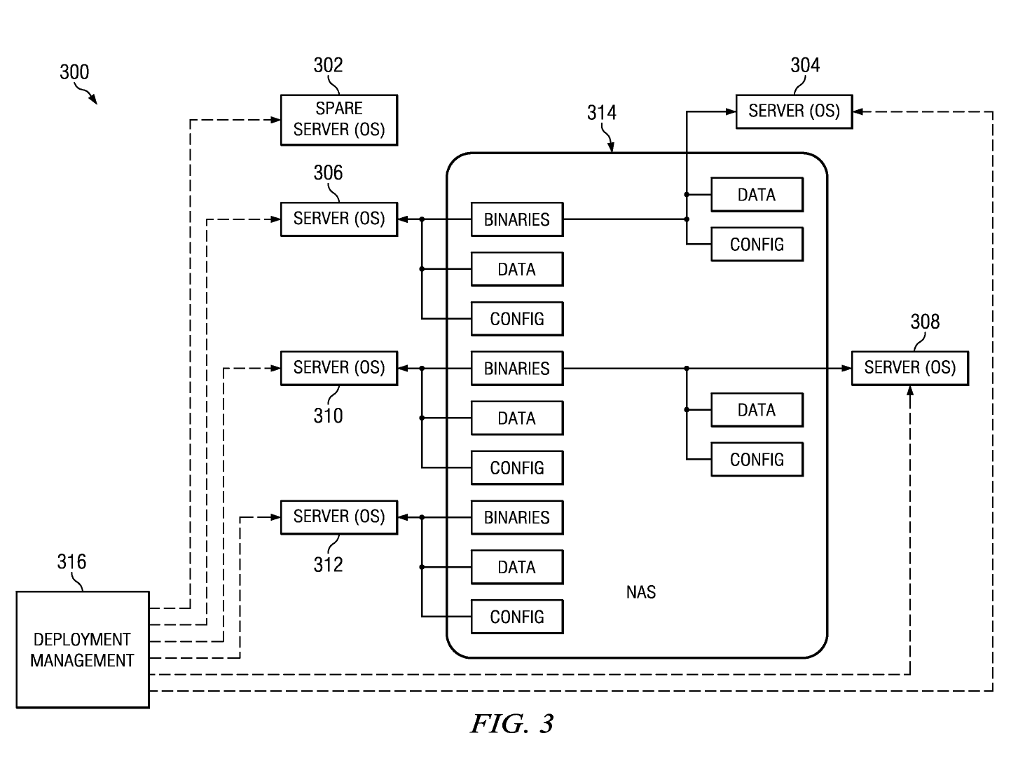

The example application deployment environment (300) of FIG. 3 includes a spare server (302) and five servers with deployed applications (304, 306, 308, 310, 312). The application binaries, application data, and configuration information for the deployed applications are stored in network-attached storage (NAS) (314). As can be seen from this example, similar to the example of FIG. 2, the deployed applications each have their own data and configuration information. However, the deployed applications on server (304) and server (306) are instantiated from the same binaries, as are the deployed application on servers (308) and server (310). In this application deployment environment, application deployment may be performed automatically as previously described. That is, to move an application from a server, e.g., server (306), to another server such as the spare server (302), a user may request via the deployment management component (316) that the application be deployed into the application deployment environment (300), and the deployment management component (316) will locate an appropriate server in the application deployment environment (300) and activate the configuration control stub (not specifically shown) on the selected server to initiate the deployment.

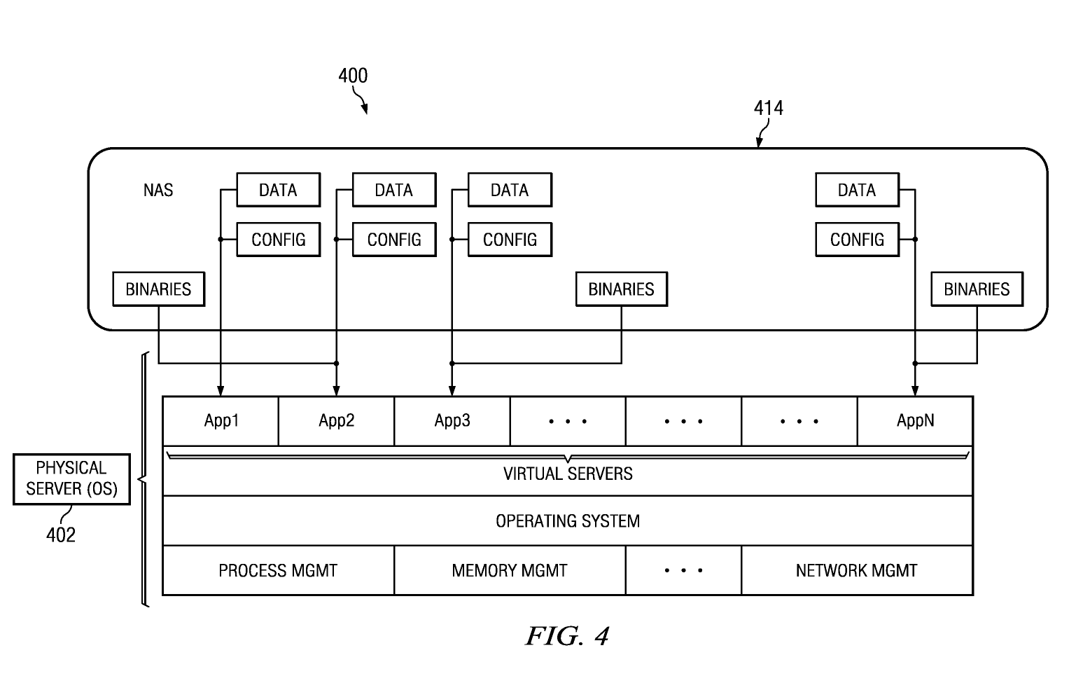

The example application deployment environment (400) of FIG. 4 illustrates the use of virtual servers. The virtual servers are created on top of the operating system of the physical server (402) using virtualization software, e.g., Solaris Zones and applications are deployed on the virtual servers. The application binaries, application data, and configuration information for the deployed applications are stored in network-attached storage (NAS) (414). As can be seen from this example, similar to the examples of FIG. 2 and FIG. 3, the deployed applications each have their own data and configuration information. However, the some of the deployed applications are instantiated from the same binaries. In this application deployment environment, application deployment is performed manually by a user in a similar fashion to that previously described. That is, to move an application from one virtual server to another virtual, a user selects a virtual server for the deployment, and manually activates the configuration control stub (not specifically shown) on the selected virtual server to initiate the deployment. In some instances, the user may create a virtual server on the physical server (402) specifically for deployment of the application.

FIGS. 5A-10D show examples of various aspects of an embodiment of the invention. Many of these examples use terminology, notations, file naming conventions, etc. that are well-known to those familiar with UNIX operating systems, and are not explained in detail. FIGS. 5A and FIG. 5B show an example of deploying an application named aldaps to a virtual server (502) in an application deployment environment, e.g., the application deployment environment of FIG. 4. The virtual server (502) is implemented on a physical server (500), with the host name dlet10, using Solaris Zones virtualization software. In the example embodiment, the application binaries (App) and the application data (Database) are stored in network-attached storage (NAS) (504). While this example illustrates deployment to a virtual server, deployment to a physical server would be similar. Further, deployment to virtual servers using other virtualization software would be similar.

Referring first to FIG. 5A, a configuration control stub (506) is installed on the physical server (500). The configuration control stub (506) includes two files, appstart.env and appstart.sh, that are placed in the directory /etc/init.d of the physical server (500). The file appstart.sh file is an application startup script and includes a link to /etc/rc3.d/S99appstart. The appstart.env file specifies the filer, e.g., an NAS device, to mount for access to a shared central repository called “/servers” which stores the remaining scripts that control the application deployment to the virtual server (502), i.e., the application configuration engine. An example of an appstart.env file is shown in Table 1 below. The mounting of /servers is performed by the application startup script in the file appstart.sh. This startup script takes as a parameter an identifier for the application to be deployed on the virtual server (502), which in this example is the application aldaps. This script reads the file /etc/appstart.env to determine which NAS filer to use to mount /servers, which in this example is the NAS (504).

TABLE 1

[LEPROD] Lewisville General Production
filer = pocket.dal.design.ti.com
share = /vol/fvol36/servers

Referring now to FIG. 5B, /servers includes two files, appstart.pl and appstart.cfg. These two files are the core of the application configuration engine in this example embodiment. The appstart.cfg file includes top level configuration information, i.e., application configuration templates, for each application that may be deployed in the application deployment environment. That is, for each deployable application, the file includes an application configuration template that designates where the application is to be deployed. The appstart.pl file is a script that controls the deployment of applications to servers in the application deployment environment based on the application configuration templates in the appstart.cfg file. Other scripts (not specifically shown) that are used by appstart.pl are also includes on/servers. In this example embodiment, these scripts and appstart.pl are implemented using the Perl scripting language. Other scripting languages may be used.

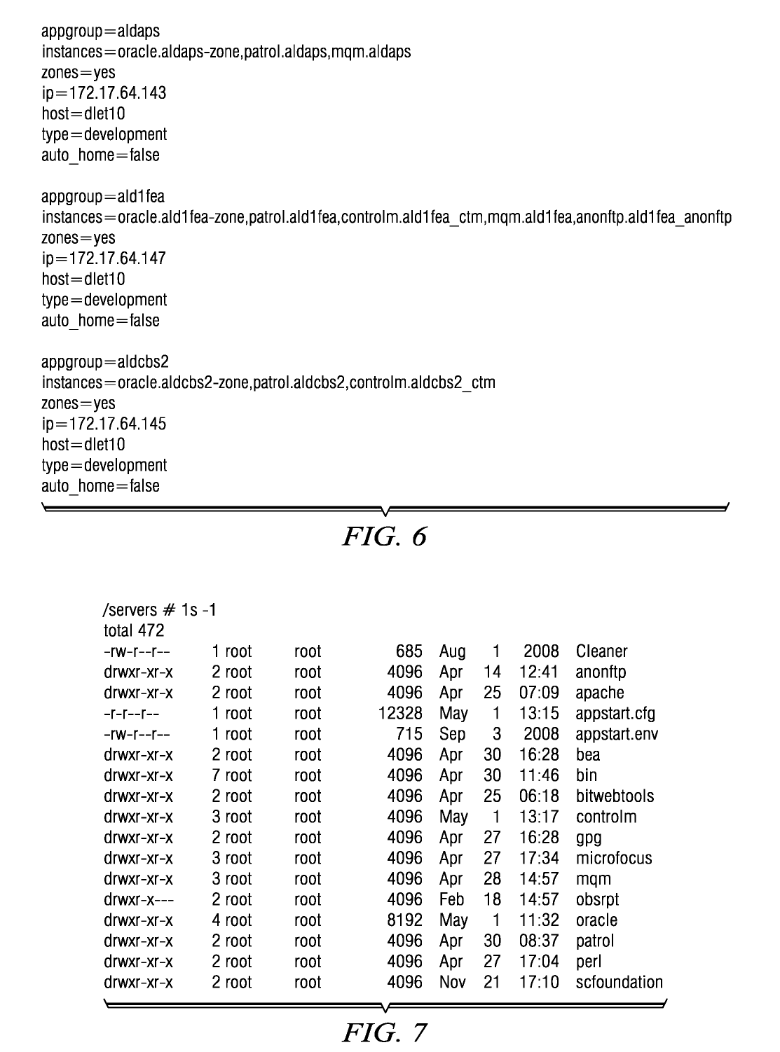

An example of a portion of an appstart.cfg file is shown in FIG. 6. In this example, three application configuration templates, designated as application groups (appgroup) in the file, are specified for deployment on the physical server (500). An application group represents a specific deployable application in the application deployment environment. Further, the name of an application group is a unique identifier for a server, i.e., the designated host name of the server where the application is to be deployed. In the example of FIG. 6, the top application group is the application configuration template for aldaps, which is the host name of the virtual server (502). The other two application groups are application configuration templates for applications to be deployed on other virtual servers on the physical server (500), which has a host name of dlet10. Note that an application configuration template includes fields for specifying the host name of the server to which an application is to be deployed (appgroup), the software included in the application (instances), whether or not the particular server to which the application is to be deployed is a virtual server (zones), the IP address of the server (ip), the host name of the physical server (host), a server type (type), and whether or not auto-mounted home directories should be set up (auto_home). Other information not specifically shown in FIG. 6, such as, for example, the operating system type and version, may also be included in an application configuration template.

The software packages to be included in the application (instances) are designated by specifying the file names of instance configuration scripts for each software package, i.e., software instance, included in the application. Instance configuration scripts are described in more detail below in reference to FIGS. 7-9. In this example, three software instances are designated for instantiation on the virtual server (502), Oracle, Patrol, and MQM.

Referring again to FIG. 5B, once /servers is mounted, the startup script in appstart.sh on the virtual server (502) causes the configuration script in /servers/appstart.pl to be executed on the virtual server (502). This configuration script parses the appstart.cfg file, i.e., the configuration file, to locate the application configuration template for aldaps. Once the application configuration template is found, the configuration script performs some validation. This validation includes ensuring that the configuration control stub (506) is a valid configuration control stub for the application deployment environment. The configuration script also performs validation of the physical server (500) against the application configuration template such as ensuring that the operating system is a valid choice for the application that is being deployed to the virtual server (502). In addition, validation may include ensuring other resource requirements of the application, e.g., memory, network, etc., are matched by resources of the physical server (500) if needed.

After validation, the configuration script then causes various actions to be performed to deploy the application on the virtual server (502) including creating the virtual server (502) and causing the execution of the designated instance configuration scripts to instantiate the aldaps application on the virtual server (502). Creating the virtual server (502) includes creating a zone on the physical server (500), assigning a host name of aldaps to the zone, and associating the IP address in the application configuration template for aldaps with the zone. Once the aldaps application is instantiated in the virtual server (502), the configuration script then starts the application on the virtual server (502).

In the /servers repository, there is a directory for every software package that is available for use in an application. For example, there is a directory for each of the software packages that are listed in the application configuration template for aldaps, i.e., Oracle, Patrol, and MQM. FIG. 7 shows an example of a directory listing for /servers. Each directory contains an instance configuration file, i.e., an instance configuration script, for each deployable application that has an instance of the software package designated in its application configuration template. For example, the directory /servers/oracle, shown in FIG. 8, contains one instance configuration file for each application configuration template that includes an instance of Oracle. Note that the application configuration template for aldaps includes an instance of Oracle, and thus there is an aldaps.cfg file in the directory shown in FIG. 8. Referring back to the configuration file of FIG. 6, the application configuration templates for the application ald1fea and the application aldcbs2 also include instances of Oracle. Thus, there are also correspondingly named instance configuration files in the directory of FIG. 8.

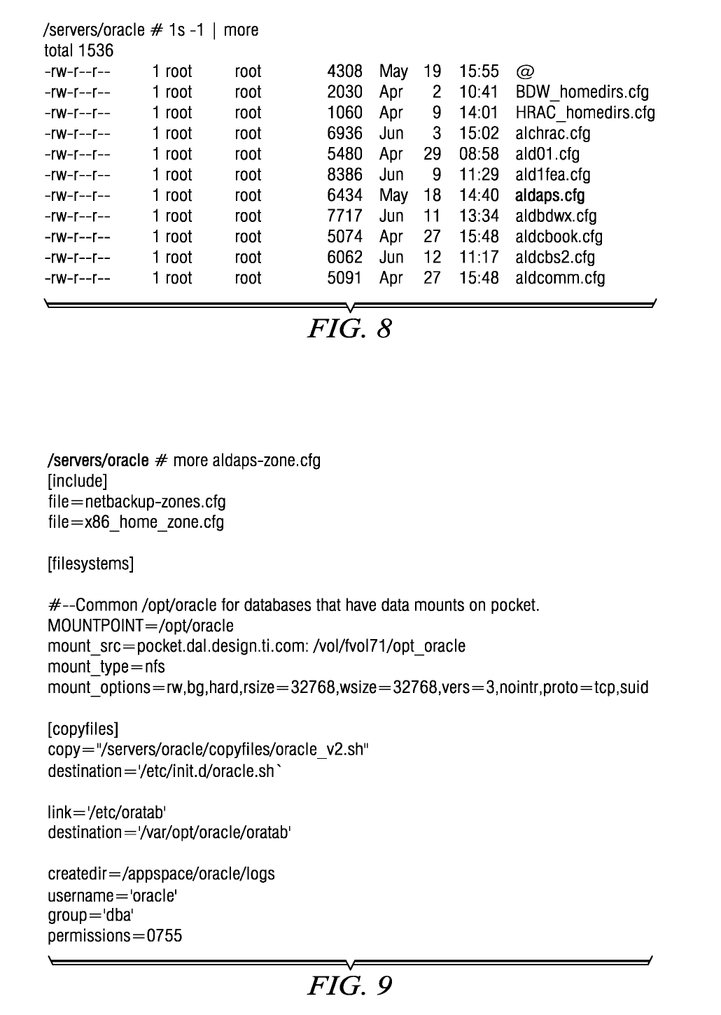

FIG. 9 shows an example of a portion of an instance configuration file. In general, an instance configuration file includes the information needed to configure an instance of a software package for a particular application. As shown in the example of FIG. 9, an instance configuration file is a script specifying the actions to be performed to instantiate an instance of the software package. In particular, FIG. 9 shows an instance configuration script for instantiating Oracle as part of the aldaps application.

In the above described example embodiment, to move the aldaps application to another virtual server on the same physical server (500), an administrator accesses the physical server (500), stops the aldaps application, deletes the zone/virtual server (502), and then activates the configuration control stub, supplying the name of the aldaps application as a parameter (506). As was previously described, a new zone/virtual server will then created on the physical server (500) with the host name aldaps and the application will be instantiated in the new zone/virtual server.

Further, to move the aldaps application to a virtual server on a different physical server (500), an administrator changes the host name in the aldaps application configuration template to be that of the new physical server, accesses the physical server (500) and stops the aldaps application, and then accesses the new physical server to activate a configuration control stub on the new physical server, supplying the name of the aldaps application as a parameter. A new zone/virtual server with the host name aldaps will then be created on the new physical server as described above and the application will be instantiated in the new zone/virtual server.

In addition, to move the aldaps application to a different physical server with no virtualization, an administrator changes the host name in the aldaps application configuration template to be that of the new physical server and changes the zones field to no to indicate that a virtual server is not to be created, accesses the physical server (500) and stops the aldaps application, and then accesses the new physical server to activate a configuration control stub on the new physical server, supplying the name of the aldaps application as a parameter. The application will then be instantiated on the new physical server in a similar fashion to that described above except that no virtual server will be created. Note that for each of the above moves, no data will be lost as the data is decoupled from the application and stored in the NAS (504). In addition, each time the application is re-instantiated, it is re-instantiated using configuration files that are stored (and maintained) in the NAS (504) and not on a server hosting the application.

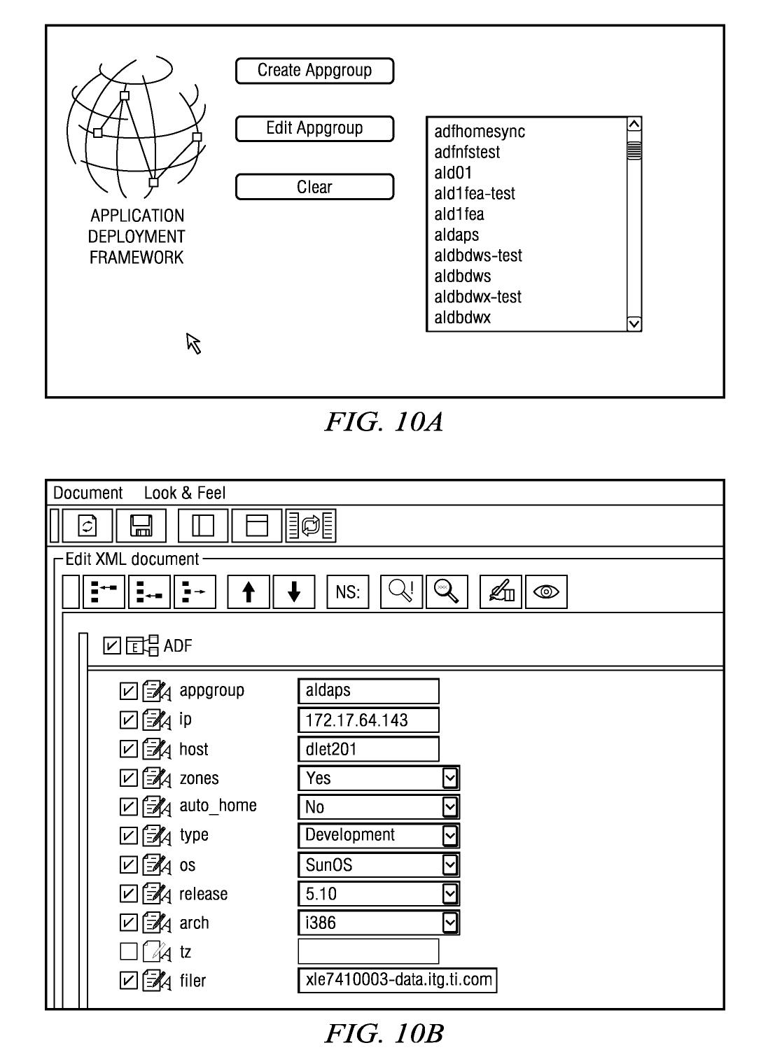

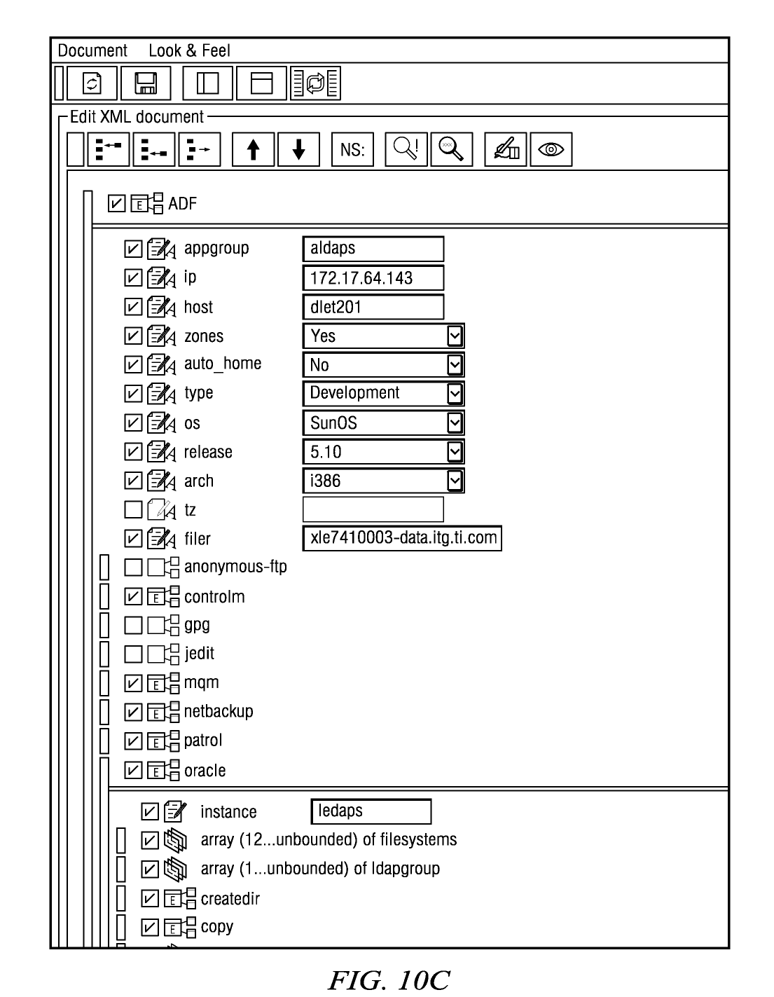

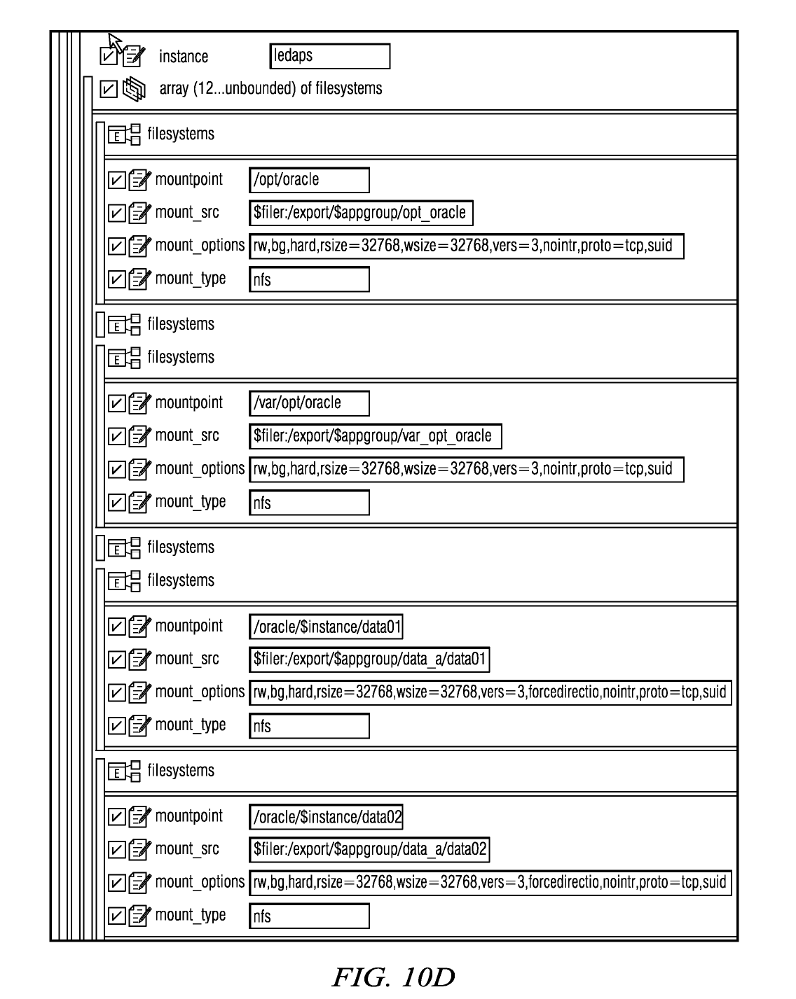

FIGS. 10A-10D show an example of a user interface for defining and maintaining application configuration templates and/or instance configuration scripts in accordance with one or more embodiments of the invention. More specifically, the depicted user interface is an example of a web interface for an application configuration maintenance component (104) of FIG. 1. As shown in FIG. 10A, the initial screen of the user interface provides options for creating an application group, i.e., an application configuration template and for editing existing application groups. To edit an existing application group, the name may be selected from a list. FIG. 10B shows an example of the top portion of the screen displayed when the application group aldaps is selected from the list. Data entry fields are provided for editing the application configuration template for aldaps, a portion of which is shown in FIG. 6.

FIG. 10C shows an additional portion of the screen where software instances included in the aldaps application are selected with check boxes. The selected software instances are included in the instances portion of the software configuration template for aldaps. For each of the selected software instances, another portion of the screen may be activated for editing the corresponding instance configuration script. FIG. 10D shows the options provided for editing the instance configuration script for Oracle. FIG. 9 shows a portion of the instance configuration script created from the information on this screen.

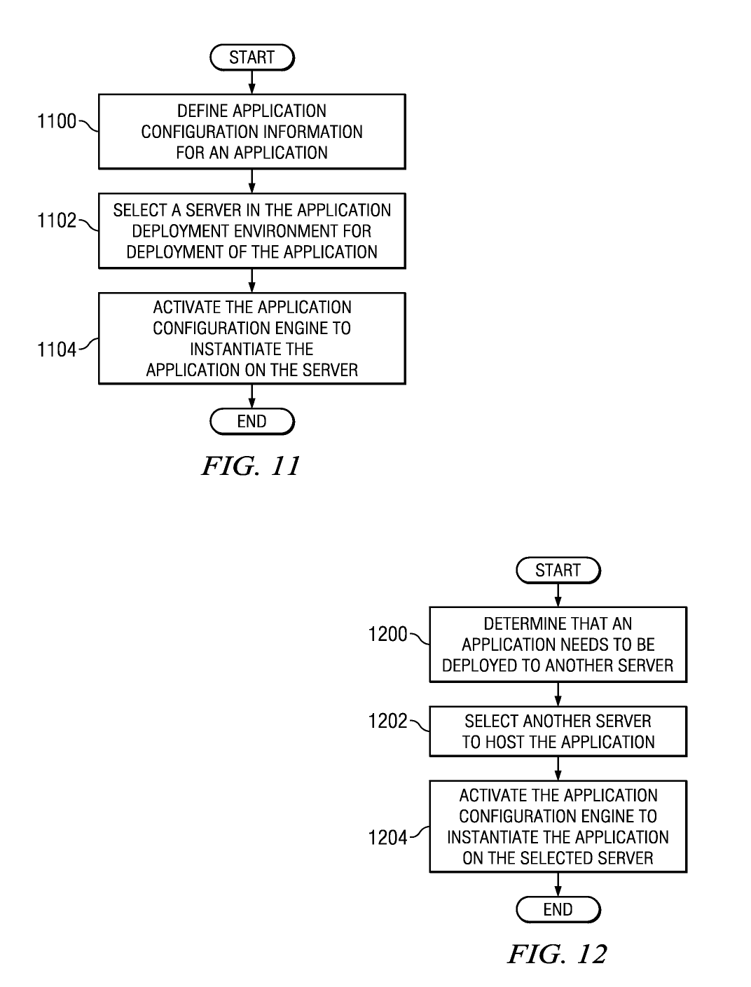

FIGS. 11-13 show flow diagrams of methods for deploying applications in an application deployment environment connected to an application deployment repository in accordance with one or more embodiments of the invention. As shown in FIG. 11, initially, application configuration information is defined for an application and stored in the application deployment repository (1100). The application configuration information may be created by a user, e.g., a system administrator, using an application configuration maintenance component. The application configuration information may include an application configuration template and one or more instance configuration scripts.

A server in the application deployment environment may then be selected for deployment of the application (1102). In some embodiments of the invention, a user may select the specific server for the deployment. In some embodiments of the invention, a user may use a deployment management component provided by the application deployment repository to automate the selection of a server as previously described. In one or more embodiments of the invention, the application configuration information is modified to identify the selected server.

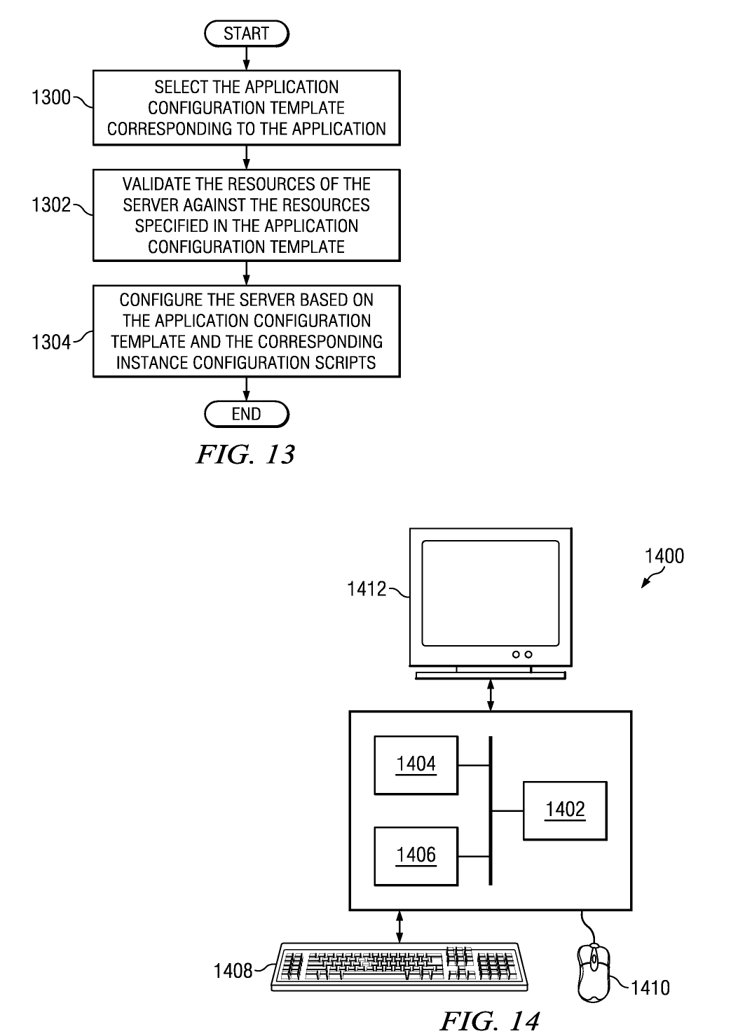

An application configuration engine provided by the application deployment repository is then activated to instantiate the application on the server (1104). The application configuration engine manages the instantiation of the application using the application configuration information for the application. In some embodiments of the invention, the application configuration engine is activated by activating a configuration control stub on the selected server that in turn activates the application configuration engine. A method for instantiating an application is described in reference to FIG. 13.

FIG. 12 shows a block diagram of a method for redeploying an application in the application development environment in accordance with one or more embodiments of the invention. The method assumes that an application has been deployed on a server in the application development environment by the application configuration engine using the application configuration information for that application. As shown in FIG. 12, initially a determination is made that an application needs to be deployed to another server, e.g., because the server where the application is deployed has failed or the application needs additional resources not available on the current server. In some embodiments of the invention, this determination may performed by a user, e.g., a system administrator. In some embodiments of the invention, the determination may be made programmatically by a deployment management component monitoring the application development environment.

Another server in the application deployment environment may then be selected to host the application, i.e., for re-deployment of the application (1202). In some embodiments of the invention, a user may select the specific server for the re-deployment. In some embodiments of the invention, a user may use a deployment management component provided by the application deployment repository to automate the selection of the new server as previously described. In one or more embodiments of the invention, the application configuration information is modified to identify the selected server. The new server may have the same operating system as the previous server or may have a different operating system.

The application configuration engine provided by the application deployment repository is then activated to instantiate the application on the selected server (1204). The application configuration engine manages the instantiation of the application using the application configuration information for the application. In some embodiments of the invention, the application configuration engine is activated by activating a configuration control stub on the selected server that in turn activates the application configuration engine. A method for instantiating an application is described in reference to FIG. 13.

FIG. 13 shows a block diagram of a method for instantiating an application on a server in the application development environment in accordance with one or more embodiments of the invention. This method may be performed for the application configuration engine in some embodiments of the invention. As shown in FIG. 13, initially the application configuration template corresponding to the application is selected (1300). Then, the resources of the server to which the application is to be deployed are validated against resources specified in the application configuration template (1302). Assuming the validation is successfully, the server is then configured based on the application configuration template and the corresponding instance configuration scripts identified in the template (1304).

FIG. 14 shows a block diagram of an illustrative server (1400) that includes a processor (1402), associated memory (1404), a storage device (1406), and numerous other elements and functionalities typical of servers (not shown). In one or more embodiments of the invention, the server (1400) may include multiple processors and some or all of the associated memory (1404) may be shared by the multiple processors. The server (1400) may also include input means, such as a keyboard (1408) and a mouse (1410) (or other cursor control device), and output means, such as a monitor (1412) (or other display device). The server (1400) may be connected to a network (not shown) (e.g., a local area network (LAN), a wide area network (WAN) such as the Internet, a cellular network, any other similar type of network and/or any combination thereof) via a network interface connection (not shown). Those skilled in the art will appreciate that the input and output means may take other forms. Further, those skilled in the art will appreciate that one or more elements of the server (1400) may be located at a remote location and connected to the other elements over a network. In addition, those skilled in the art will appreciate that if the server (1400) is a virtual server, one or more of the elements may be virtualized elements of a physical server.

Software instructions, scripts, files, etc. to perform embodiments of the invention may be stored on a computer readable medium such as a compact disc (CD), a diskette, a tape, a file, memory, or any other computer readable storage device or any combination thereof. The software instructions, scripts, files, etc. may be distributed to the server (1400) via removable computer readable media (e.g., floppy disk, optical disk, flash memory, USB key), via a transmission path from a computer readable medium on another server, network-attached storage device, etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method of deploying applications in an application deployment environment comprising a plurality of servers, the method comprising:
selecting an application for deployment on a first server in the plurality of servers; and
activating an application configuration engine provided by a central deployment repository, wherein the application configuration engine instantiates the application on the first server based on configuration information for the application stored in the central deployment repository.

2. The method of claim 1, wherein activating an application configuration engine comprises:
activating a configuration control stub on the first server, wherein the configuration control stub is configured to activate the application configuration engine.

3. The method of claim 1, wherein the configuration information comprises an application configuration template and the application configuration engine comprises a configuration script configured to control instantiation of the application based on the application configuration template.

4. The method of claim 1, wherein the server is a virtual server.

5. The method of claim 1, wherein the application configuration information identifies at least one software instance included in the application.

6. The method of claim 5, wherein the application configuration information comprises an instance configuration script for the at least one software instance.

7. The method of claim 1, the method further comprising:
selecting the application for deployment on a second server of the plurality of servers; and
activating the application configuration engine, wherein the application configuration engine instantiates the application on the second server based on the configuration information for the application.

8. The method of claim 7, wherein the first server comprises a first operating system and the second server comprises a second operating system different from the first operating system.

9. The method of claim 1, wherein selecting the application comprises programmatically selecting the first server based on the configuration information of the application, and activating an application configuration engine is performed programmatically after selection of the first server.

10. The method of claim 1, further comprising:
modifying a portion of the configuration information for the application; and
activating the application configuration engine, wherein the application configuration engine instantiates the application on the first server based on the modified configuration information.

11. A system comprising:
an application deployment environment comprising a plurality of servers; and
a central deployment repository connected to the application deployment environment, wherein the central repository comprises:
application configuration information for each application of a plurality of applications; and
an application configuration engine configured to instantiate the plurality of applications in the application deployment environment based on the respective application configuration information of the applications,
wherein when an application of the plurality of applications is selected for deployment on a first server of the plurality of servers, the application configuration engine is activated to instantiate the application on the first server using the application configuration information for the application.

12. The system of claim 11, wherein the central deployment repository further comprises:
binaries for software instances included in the plurality of applications.

13. The system of claim 11, wherein the central deployment repository further comprises:
an application configuration maintenance component configured for creating and maintaining the application configuration information.

14. The system of claim 11, wherein the central repository further comprises:
a deployment management component configured to manage deployment of the plurality of applications to the plurality of servers.

15. The system of claim 14, wherein the deployment management component is configured to select a server for deployment of an application in the plurality of applications, and to activate the application configuration engine to instantiate the application on the selected server using the application configuration information for the application.

16. The system of claim 11, wherein the application configuration engine comprises a configuration script configured to control instantiation of any application in the plurality of applications to any server in the plurality of servers.

17. The system of claim 16, wherein the application configuration information for each application comprises an application configuration template and at least one instance configuration script, and wherein the configuration script controls instantiation of each application using the respective application configuration template and the respective at least one instance configuration script.

18. The system of claim 11, wherein each server of the plurality of servers comprises a configuration control stub configured to initiate deployment of an application to the server by activating the application configuration engine.

19. The system of claim 11, wherein when the application is selected for deployment to a second server of the plurality of servers, the application configuration engine is activated to instantiate the application on the second sever using the application configuration information for the application.

20. The system of claim 19, wherein first server comprises a first operating system and the second server comprises a second operating system different from the first operating system.
